(19) United States
(12) Patent Application Publication
(10) Pub. No.: US 2012/0151777 A1
(43) Pub. Date: Jun. 21, 2012

(54) KNIFE WITH BALANCE ADJUSTMENT FEATURE

(76) Inventor: Douglas S. Ritter, Gilbert, AZ (US)

(21) Appl. No.: 13/316,797

(22) Filed: Dec. 12, 2011

Related U.S. Application Data
(60) Provisional application No. 61/424,538, filed on Dec. 17, 2010.

(51) Int. Cl. B26B 3/00

(52) U.S. Cl. 30/165

(57) ABSTRACT

A knife is provided with a balance adjusting feature. The knife may have a blade and a handle tang. The handle has at least one balance mount, each balance mount comprising an aperture in the tang. Each balance mount is configured to accept at least one balance weight. By connecting or disconnecting weights from the balance mounts, the center of mass of the knife changes, thus permitting a user to customize the balance of the knife.

### RELATED APPLICATION DATA

This application claims priority to U.S. Provisional Application Ser. No. 61/424,538, filed Dec. 17, 2010.

### FIELD OF THE INVENTION

The present invention relates to knives.

### BACKGROUND OF THE INVENTION

Knives come in a variety of styles and configurations. In general, most knives have a simple configuration of a blade and a handle portion.

Despite this simple configuration, the design of a knife can significantly impact its functionality, including its ease of use. For example, the shape of the handle can significantly impact the ease with which the knife can be grasped.

A particular feature of a knife that significantly impacts its use is its balance. In general, the location of the center of mass of a knife can impact its feel, ease of use and functionality for particular purposes. A knife maker may control the position of the center of mass by changing the mass or size of the blade relative to the mass or size of the handle. However, the center of mass selected by the knife maker may not result in a balance which is desired by all users. In particular, different users may desire different knife balance to improve the personal feel of the knife and/or based upon the user's intended purpose for the knife.

A knife having a variable or adjustable balancing feature is desired.

### SUMMARY OF THE INVENTION

The invention comprises a knife having a balance adjusting feature and a method of changing the center of mass of a knife, and thus the balance of the knife.

In one embodiment the knife has a handle comprising a tang having a first end and a second end. The knife also has a blade having a first end and a second end, the first end of the blade comprising a first end of the knife and the second end of the blade connected to the first end of the handle, the second end of the handle comprising a second end of the knife, and the blade having at least one cutting edge.

The handle has at least one balance mount. In a preferred embodiment, the handle has a plurality of balance mounts, each balance mount comprising apertures in different locations of the tang between the first and second ends of the handle, each balance mount configured to accept a balance weight.

The balance mounts are each configured to removably or detachably accept at least one balance weight. In one embodiment, the apertures comprising the balance mounts are threaded for receiving mating threads on the balance weights.

In accordance with a method, balance weights may be connected to or disconnected from the knife, such as by threading them into or out of the apertures comprising the balance mounts. Connecting balance weights to the knife or disconnecting balance weights from the knife changes the center of mass of the knife, and thus its balance.

In accordance with the invention, each user of the knife may customize the knife by changing the number of balance weights associated with the knife and/or their position, thus changing the balance of the knife to meet the user's desires. Advantageously, the balance adjustment feature of the knife is reversible or changeable, thus permitting a single user to adjust the balance of the knife or permitting different users of a single knife to adjust the balance thereof over time.

Further objects, features, and advantages of the present invention over the prior art will become apparent from the detailed description of the drawings which follow, when considered with the attached figures.

### DESCRIPTION OF THE DRAWINGS

FIG. 1 illustrates a knife having a balance adjustment feature in accordance with the present invention; and

FIG. 2 illustrates in greater detail a balance weight and balance mount of the knife illustrated in FIG. 1.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a knife having a balance adjustment feature.

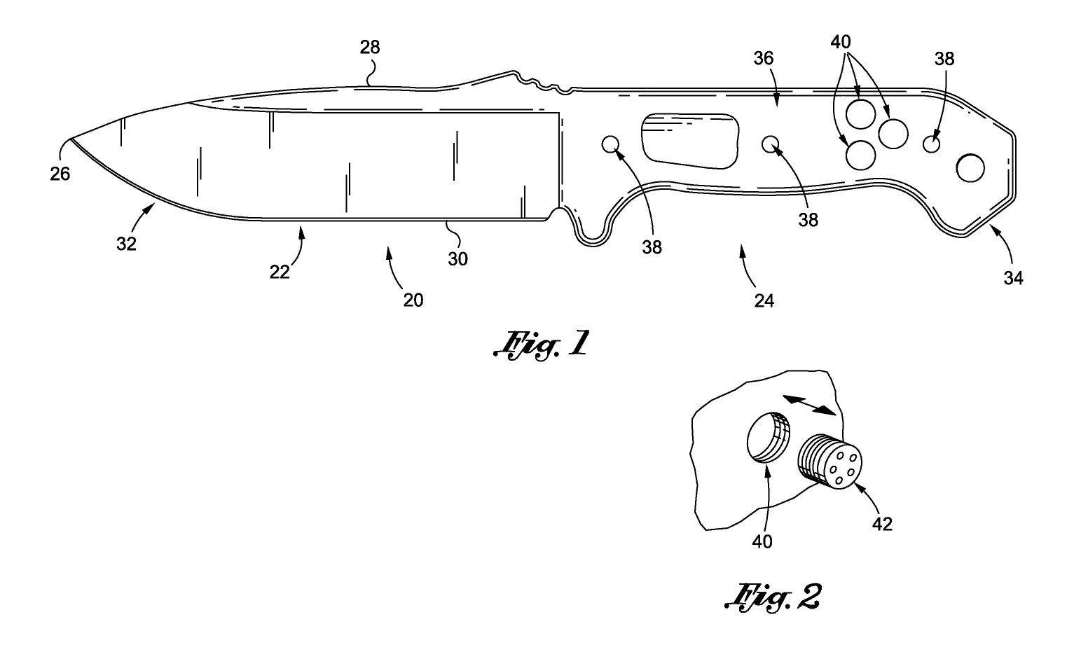

FIG. 1 illustrates one embodiment of a knife 20 of the invention. It will be appreciated that the invention may be applied to knives having other shapes and configurations.

As illustrated in FIG. 1, the knife 20 has a blade 22 and a handle 24. The blade 22 comprises a body having a first end and a second end. A first end of the blade 22 preferably comprises a first end of the knife 20. The first end of the blade 22 may comprise a point 26, though in particular implementations the point 26 need not be sharp as illustrated. A second end of the blade 22 is connected to the handle 24.

While the blade 22 may have a variety of shapes and configurations, in one embodiment the blade 22 has a top edge 28 and a generally opposing bottom edge 30. At least a portion of the bottom edge 30 is preferably tapered to a relatively thin cutting edge. A forward portion of the bottom edge 30 near the point 26 comprises a tip 32 of the blade 22.

The handle 24 comprises a body having a first end and a second end. In one embodiment, the first end of the handle 24 is connected to the second end of the blade 22. The connection of the blade 22 to the handle 24 may be at a bolster, as is well known in the art. The second end of the handle 24 preferably comprises a second end of the knife 20. The second end of the handle may comprise a butt 34.

In general, the knife 20 is generally planar, having a first side and an opposing second side. The knife 20, including the blade 22 or handle 24, may have various other features, such as a serrated cutting edge or the like. Further, it will be appreciated that the shape of the handle 24 may vary from that illustrated. For example, the thickness of the handle 24 may vary, such as being thicker in one or more areas than others.

In one embodiment, the portion of the handle 24 of the knife 20 illustrated in FIG. 1 is referred to as the “tang” 36. The handle 24 preferably further comprises a cover, such as first and second scales (not shown) mounted to the tang 36 at opposing sides of the handle 24 of the knife or a handle or cover that completely surrounds the tang covering it completely. The scales may be constructed of various materials, such as wood, plastic or the like, and generally increase the width of the knife 20 at the handle 24 for easier gripping. The scales may be connected to the tang 36 via one or more rivets or other fasteners (not shown) which engage rivet apertures 38 in the tang 36. In order to facilitate access to the knife balancing feature described below, the scales may be removably mounted to the tang 36, such as with threaded fasteners, or may include one or more openings, such as to permit access to balance mounts 40 as described in detail below. Of course, it is also possible for the handle 24 to not include a cover or scales.

FIG. 1 illustrates a fixed-blade knife. In such a configuration, the blade 22 is not moveable relative to the handle 24, but is instead mounted in a fixed position relative to the handle 24. In this configuration, the body defining the blade 22 and the body defining the handle 24 may be one and the same, wherein the knife 20 comprises a unitary body (except for the scales). In other embodiments, it is possible for the blade 22 and the handle 24 to be removably attached, but where the blade 22 may only be attached to the handle 24 in a single orientation or position.

It is possible, however, for the knife 20 of the invention to have a movable blade 22, such a one which may translate or rotate relative to the handle 24.

In accordance with the invention, the knife 20 has a balancing feature. In general, the balancing feature permits a user to adjust or change the center of mass of the knife 20.

In its base configuration as detailed above wherein the knife 20 has a blade 22 and a handle 24, the knife 20 has a base center of mass. The base center of mass is determined by the size of the blade 22 and the handle 24 and the masses thereof.

In accordance with the invention, the balance adjustment feature of the knife 20 permits the base center of mass of the knife 20 to be changed. In a preferred embodiment, the knife 20 includes one or more balance member mounts 40. The mounts 40 may each comprise an aperture in the knife 20, and preferably in the tang portion 36 of the handle 24. In a preferred embodiment the apertures extend entirely through the tang 36, though depending upon the thickness of the tang 36, the aperture might only extend into the tang 36 (i.e. merely comprise a recessed area of the tang 36).

Preferably, a plurality (at least two) balance member mounts 40 are provided at different locations of the knife 20. The particular locations of the mounts 40, as well as their number, may vary, depending upon the level of balance adjustment which is desired. One or more balance mounts 40 may be provided at different locations in a direction parallel to a line extending through the length of the knife 20 from end-to-end. In addition, one or more balance mounts 40 may be provided at different locations in a direction parallel to a line extending through the knife 20 from edge to edge (i.e. in a direction perpendicular to a line through the knife from end-to-end), as illustrated in FIG. 1.

Each balance member mount 40 is preferably configured to accept one or more weights 42, as illustrated in FIG. 2. The weights 42 each comprise a body having a mass, whereby association or disassociation of each weight 42 with the knife 20 changes the mass of the knife and the center of mass of the knife.

In one embodiment, means are provided for selectively attaching and detaching the weights 42 from the knife 20. This means may comprise a threading engagement of the weights 42 with the mounts 40.

As best illustrated in FIG. 2, the aperture comprising each mount 40 may be threaded for accepting mating threads on a corresponding weight 42. In this manner, a weight 42 may be 42 threadingly engaged with a mount 40 or threadingly disengaged from a mount 40.

The weights 42 and the mounts 40 may have various configurations. In order to permit the threading engagement thereof, at least a portion of the mount 40 comprises a cylindrical threaded opening and likewise a portion of the weight 42 comprises a mating threaded body portion.

The weights 42 may, however, have a head having various shapes. As illustrated in FIG. 2, the weight 42 is generally cylindrical in shape. In other embodiments, it could have a head which is enlarged relative to a shank portion thereof.

In one embodiment, the thickness or depth of each weight 42 may be equal to or less than the thickness of the knife 20 at the mounts 40, whereby the weights 42 do not extend outwardly beyond the outside surface of the tang 36. In an embodiment where the weights 42 include an enlarged head, a portion of each mount 40 may be countersunk in order to accept the head of a weight 42 therein so that the head of the weight does not extend outwardly beyond the outside surface of the tang 36. This may be beneficial so that the weight 42 does not interfere with a scale which is mounted over the tang 36. In other embodiments, as detailed above, the weight 42 may extend outwardly of the tang 36, such as into a recess formed in the overlying cover or scale (as described above).

The weight 42, such as a head portion thereof, may have a tool engaging mount, such as a socket, slot or the like for engagement by a screwdriver head, Allen wrench or the like. Also, an exterior of the head of the weight 42 could be shaped for engagement by a tool, such as having a hex-shape or the like for engagement by a wrench, socket or the like.

In use, a user may adjust or change the balance of the knife 20 by associating or disassociating one or more weights 42 with the knife 20. The user may screw or thread a weight 42 into one or more or all of the mounts 40. The number of weights 42 which are utilized, as well as the particular mounts 40 into which they are positioned, permits the center of mass to be adjusted, thereby changing the balance of the knife 20 to be changed. Notably, the association or disassociation of a weight 42 with just a single mount 40 is sufficient to change or adjust the balance of the knife 20.

It will be appreciated that the balance adjustment feature of the knife 20 permits the user (and not just the manufacturer) to change the balance of the knife, as well as to permit different users to configure the knife different from one another, and even permits a single user to change the balance of the knife (such as at different times for different uses). In addition, the balance adjustment feature of the knife is reversible, in that the knife can be modified or adjusted for one user and then changed back or further modified at a later time for that user or another user.

As one aspect of the invention, the balance adjusting feature is associated with the tang 36 of the handle 24 of the knife 20 and may be covered by one or more scale portions of the handle 24. In this manner, the balance adjusting feature may be hidden from view. In another embodiment, it is possible for the mount 40 to be associated with the one or more scales or other covers of the handle 24 as well. For example, a mount 40 might comprise an aperture which extends into a scale, into a scale and the underlying tang 36, and/or entirely through the handle 24 (i.e. through both scales and the tang 36 there between).

In one embodiment, at least the body comprising the blade 22 and the handle 24 is constructed from a durable metal (the scale portions of the handle 24 may be constructed from other material).

In one embodiment, the weights 42 are constructed from metal, but they may be constructed from other materials. The weights 42 may be constructed from different materials so that different weights 42 have different masses. For example, one weight 42 may be constructed from lead, while another might be constructed from stainless steel (whereby the two weights of the same size have different masses owing to the different specific gravities of the materials from which they are constructed).

In one embodiment, the mounts 40 may all be of the same size and thus all interchangeably accept the same weights 42. In other embodiments, one or more of the mounts 40 may have different sizes (such as different diameters). In such a configuration, the mating weights 42 for those mounts 40 may, have different sizes. It is also possible for the mounts 40 to be of the same size, but for the head portion of one or more of the weights 42 to have different sizes (whereby different weights 42 have different masses but may all interchangeably engage all of the mounts 40).

In other embodiments of the invention, the weights 42 may connect to the knife 20, including the mounts 40, in other fashions. For example, the weights 42 might be press-fit into apertures comprising the mounts 40. The weights 42 might have outwardly extending pins for engagement with mating slots of the mounts 40, including in an arrangement where rotation of the weights 42 causes the pins to turn into a locked position relative to the mounts 40.

In one embodiment, the weights 42 might comprise first and second portions which may be engaged. The first portion might be positioned at the first side of the knife 20 and the second portion might be positioned at the second side of the knife 20 and those two portions might be pressed, threaded or otherwise moved into engagement with one another through the mount 40 (whereby the first and second portions of the weight 42 connect to one another and that connection mounts the weight 42 to the knife 20).

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A knife having a balance adjusting feature comprising:
a handle comprising a tang having a first end and a second end;
a blade having a first end and a second end, said first end of said blade comprising a first end of said knife and said second end of said blade connected to said first end of said handle, said second end of said handle comprising a second end of said knife, said blade having at least one cutting edge;
said handle having at least two balance mounts, each balance mount comprising an aperture in said tang, said at least two balance mounts located in different positions of said tang between said first and second ends of said handle, each balance mount configured to accept a balance weight; and
at least one balance weight configured to be mounted to one of said at least two balance mounts.

2. The knife in accordance with claim 1 wherein said tang of said handle has a first side and a second side and further comprising a scale mounted at either or both of said sides.

3. The knife in accordance with claim 1 wherein each aperture is threaded and wherein said at least one balance weight has a mating threaded portion, whereby said at least one balance weight may be threaded into and out of engagement with each balance mount.
